(19) United States
(12) Patent Application Publication
(10) Pub. No.: US 2023/0023785 A1
(43) Pub. Date: Jan. 26, 2023

(54) KNIFE WITH BUILT-IN SHARPENER

(71) Applicant: Daniel J. Raymond, Saginaw, MI (US)

(72) Inventor: Daniel J. Raymond, Saginaw, MI (US)

(21) Appl. No.: 17/869,418

(22) Filed: Jul. 20, 2022

Related U.S. Application Data
(60) Provisional application No. 63/224,222, filed on Jul. 21, 2021.
(60) Provisional application No. 63/243,919, filed on Sep. 14, 2021.

(51) Int. Cl. B24B 3/54; B26B 1/02; B26B 1/10

(52) U.S. Cl. CPC B24B 3/54; B26B 1/02; B26B 1/10

(57) ABSTRACT

The knife includes a handle and a blade, which is pivotably connectable with the handle and is able to pivot between an open position and a closed position. A cutting edge of the blade is fully disposed within a slot in the handle when the blade is in the closed position. Clippers are incorporated into the handle and include a first clipping piece, a second clipping piece, and a lever. The first and second clipping pieces have opposing clipping edges. The lever is configured to press one of the clipping pieces towards the other clipping piece to bring the clipping pieces together.

### CROSS-REFERENCE TO RELATED APPLICATION

This utility application claims the benefit of U.S. Provisional Application No. 63/224,222 filed Jul. 21, 2021 titled “KNIFE WITH BUILT-IN SHARPENER” and U.S. Provisional Application No. 63/243,919, filed Sep. 14, 2021, and titled “KNIFE WITH BUILT-IN SHARPENER.” These provisional applications are incorporated by reference herein as if reproduced in full below.

### BACKGROUND

### 1. Field

The present disclosure is related generally to multi-purpose tools and more particularly to knives.

### 2. Related Art

Many workers carry a number of different tools with them and switch between using those tools. For example, some workers carry a jack knife, a set of clippers, and a blade sharpener as separate components. This can be cumbersome and can result in lost tools.

### SUMMARY AND ADVANTAGES

One aspect of the present disclosure is related to a knife that includes a blade which is connected with a handle. A blade sharpener is connected with the handle and detachable from the handle for sharpening a cutting edge of the blade.

According to another aspect of the present disclosure, the blade sharpener is built into a lever of a clipper that has a pair of clipping edges that can be brought together to cut an object.

According to yet another aspect of the present disclosure, the lever can be pivoted between an open position and a closed position. When the lever is in the open position, a first portion of the lever extends away from the handle and can be pressed to bring the pair of clipping edges together, and when the lever is in the closed position, the blade sharpener is hidden from view.

According to still another aspect of the present disclosure, the lever is connectable with the handle via a keeper pin.

According to a further aspect of the present disclosure, the clippers include a top clipping piece with one of the clipping edges and a bottom clipping piece with another of the clipping edges and wherein the top and bottom clipping pieces are at least partially spaced apart from one another by a gap.

According to yet a further aspect of the present disclosure, the blade of the knife is pivotable relative to the handle between a closed position and an open position, and the blade partially extends into the gap between the top and bottom clipping pieces when the blade is in the closed position.

According to still a further aspect of the present disclosure, when the blade of the knife is in the closed position, no portion of the blade is located between the clipping edges of the top and bottom clipping pieces.

According to another aspect of the present disclosure, the blade is attached with the handle through two pins that extend through a slot of the handle, and the blade sharpener includes a pair of slots that receive the pins to hold the blade sharpener in the slot of the handle.

According to yet another aspect of the present disclosure, one of the slots is keyhole shaped for receiving one of the pins. The sharpener is retained within the slot of the handle, and a tab on the sharpener extends out of the slot and can be engaged by a user to remove the sharpener from the slot of the handle.

Another aspect of the present disclosure is related to a knife that includes a handle and a blade, which is pivotably connectable with the handle and is able to pivot between an open position and a closed position. A cutting edge of the blade is fully disposed within a slot in the handle when the blade is in the closed position. Clippers are incorporated into the handle and include a first clipping piece, a second clipping piece, and a lever. The first and second clipping pieces have opposing clipping edges. The lever is configured to press one of the clipping pieces towards the other clipping piece to bring the clipping pieces together.

According to another aspect of the present disclosure, a blade sharpening material is formed into one surface of the lever.

According to another aspect of the present disclosure, the blade sharpening material includes at least one of Novaculite, aluminum oxide, or silicon carbide.

According to yet another aspect of the present disclosure, a keeper pin extends through the first and second clipping pieces and engages with the lever.

According to still another aspect of the present disclosure, the lever includes a planar first portion, which includes the blade sharpening material, and a planar second portion that engages the keeper pin. The second portion of the lever is angled relative to the first portions at an obtuse angle.

According to a further aspect of the present disclosure, when the blade is in the closed position, a portion of the blade extends into a gap between the first and second clipping pieces.

### BRIEF DESCRIPTION OF THE DRAWINGS

These and other features and advantages of the disclosure will become more readily appreciated when considered in connection with the following description of the presently preferred embodiments, appended claims and accompanying drawings, in which:

FIG. 1 is a front elevation view of a first embodiment of a knife and showing a blade in a closed condition;

FIG. 2 is another front elevation view of the first embodiment of the knife and showing the blade in an open position;

FIG. 3 is another front elevation view of the knife and showing a pair of clippers as being removed from a handle of the knife;

FIG. 4 is a front elevation view of a second embodiment of the knife and showing a blade in a closed position;

FIG. 5 is a cross-sectional view of the second embodiment of the knife and showing the blade in the closed position;

FIG. 6 is a front elevation view of the second embodiment of the knife and showing the blade in an open position;

FIG. 7 is another cross-sectional view of the second embodiment of the knife and showing the blade in the open position;

FIG. 8 is a view illustrating the second embodiment of the knife and with the blade being sharpened by a blade sharpening material on a lever of the clippers;

FIG. 9 is a front elevation view of a third embodiment of the knife;

FIG. 10 is a front elevation view of a blade sharpener of the third embodiment of the knife; and

FIG. 11 is a front elevation view of the third embodiment of the knife and showing the blade sharpener in a position for either insertion into or removal from the handle.

### DESCRIPTION OF THE ENABLING EMBODIMENT

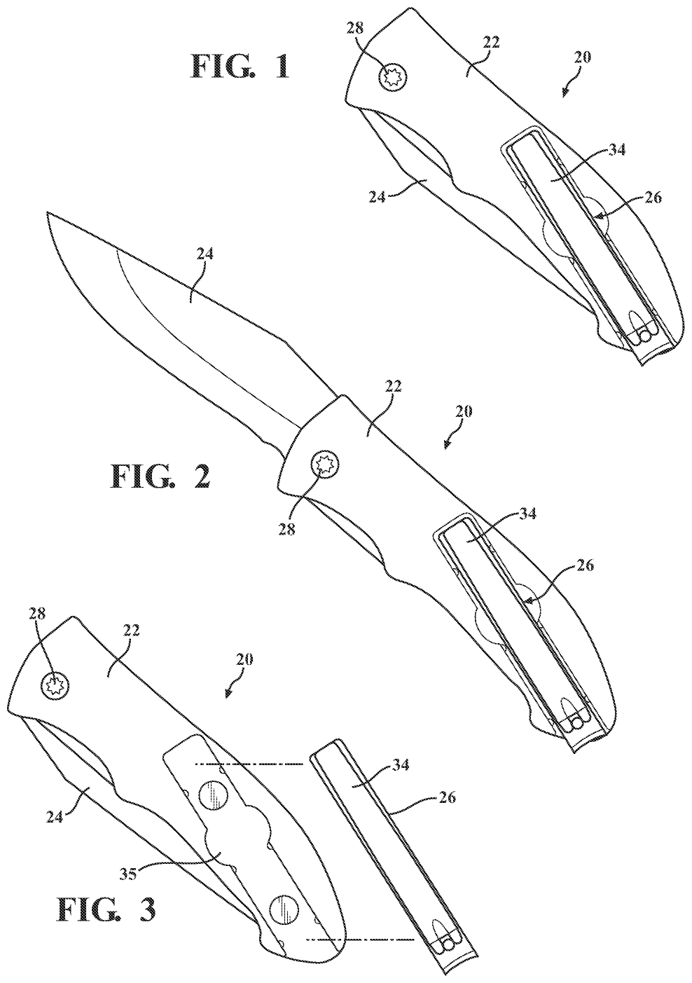

Referring to the Figures, wherein like numerals indicate corresponding parts throughout the several views, a first exemplary embodiment of the present disclosure is a knife 20 that has a handle 22 and a folding blade 24 is shown in FIGS. 1-3. Such knives of this type are sometimes known as “jack knives.” As discussed in further detail below, the utility knife 20 includes a blade sharpener and clippers 26 as integrated components. In other embodiments, the knife may be a utility knife, such as of the type having a clam shell design or of the type having a folding housing design.

The handle 22 has a slot on one of its side surfaces, and the blade 24 is attached with the handle 22 via a pivot pin 28 that extends through the handle 22, through the slot, and through the blade 24. A user can manually and easily pivot the blade 24 between an open (usable) position and a closed (stowed) position. In the closed position, a sharp cutting edge of the blade 24 is received within the slot on a side surface of the handle 22. More specifically, the handle 22 has a length that is slightly longer than the blade 24 so that the full length of the sharp edge of the blade 24 can be tucked into the slot on the handle 22 when the blade 24 is in the closed position. The knife 20 also includes a locking or retention feature that can hold the blade 24 in either the closed or open position until the user deliberately intends to pivot it to the other position, i.e., opens or closes the knife 20. Such a retention feature could include a catch and detent means which requires the user to manipulate the blade 24 or some other feature in some way to allow the blade 24 to pivot from the closed position to the open position. In an example embodiment, the user must urge the blade 24 to one side or another to unlock or disengage the locking or retention feature.

In some embodiments, the handle 22 is made as one or more pieces of injection molded plastic or rubber. In this embodiment, the clippers 26 are received into a slot of the handle 22 and include two metallic clipping pieces and a lever 34. The clipping pieces include a top clipping piece and a bottom clipping piece, which are discussed in further detail below. In this embodiment, the clippers 26 are receivable into a slot 35 on a planar surface of the handle 22 and are retained in the handle 22 by a plurality of resilient detent features that engage with the clipping pieces. The blade 24 of the knife can be sued whether the clippers 26 are received into the slot 35 or have been removed therefrom. As also discussed in further detail below, one surface of the lever 34 is provided with a blade sharpening material that can be used to sharpen the cutting edge of the blade.

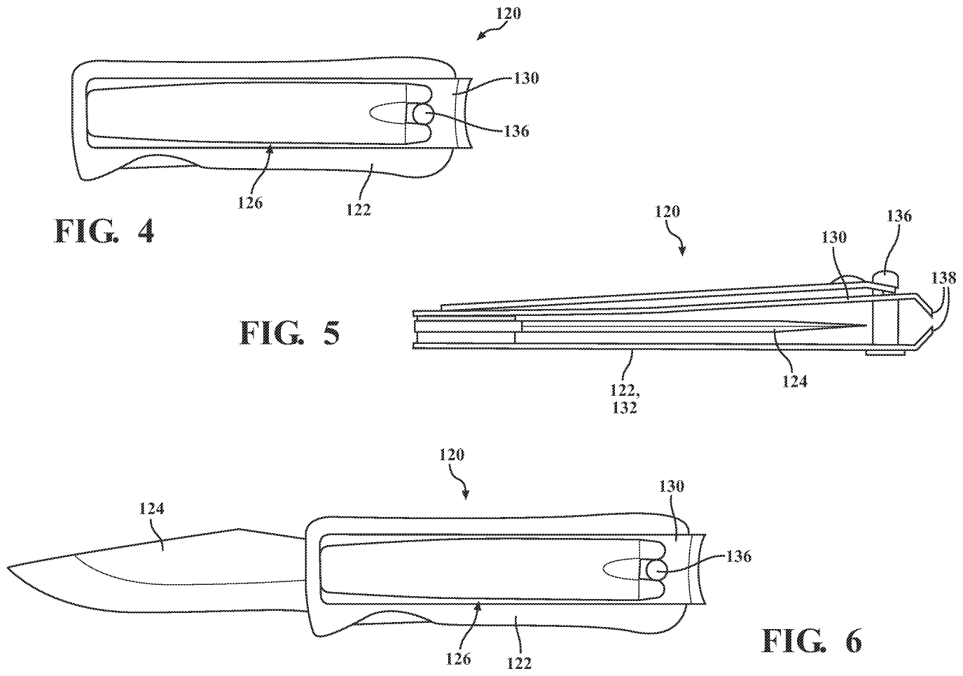

Turning now to FIGS. 4-8, a second exemplary embodiment of the present disclosure is provided wherein like numerals, separated by a prefix of “1,” identify like components with the first embodiment described above. In this embodiment, the handle 122 at least partially defines or is in a permanently fixed engagement (for example, an overmolding engagement) with the top and bottom clipping pieces 130, 132. The top and bottom pieces 130, 132 are each are generally rectangular in shape and are spaced apart from one another by a gap, which defines a portion of the slot of the handle 122. When the blade 124 is in the closed position, the blade 124 is received into this gap between the top and bottom clipping pieces 130, 132. In other words, when the blade 124 is in the closed position, a portion of the blade 124 is partially located directly between the top and bottom clipping pieces 130, 132. The top and bottom clipping pieces 130, 132 have curved or angled clipping edges 138 that converge towards one another at a location on an opposite side of the handle 122 from the pivot pin. More specifically, as shown in FIG. 5, the clipping edges 138 are spaced from an end of the blade 124 when the blade 124 is the closed position such that the clipping edges 138 can be brought together to cut something whether the blade 124 is in either the open position or the closed position.

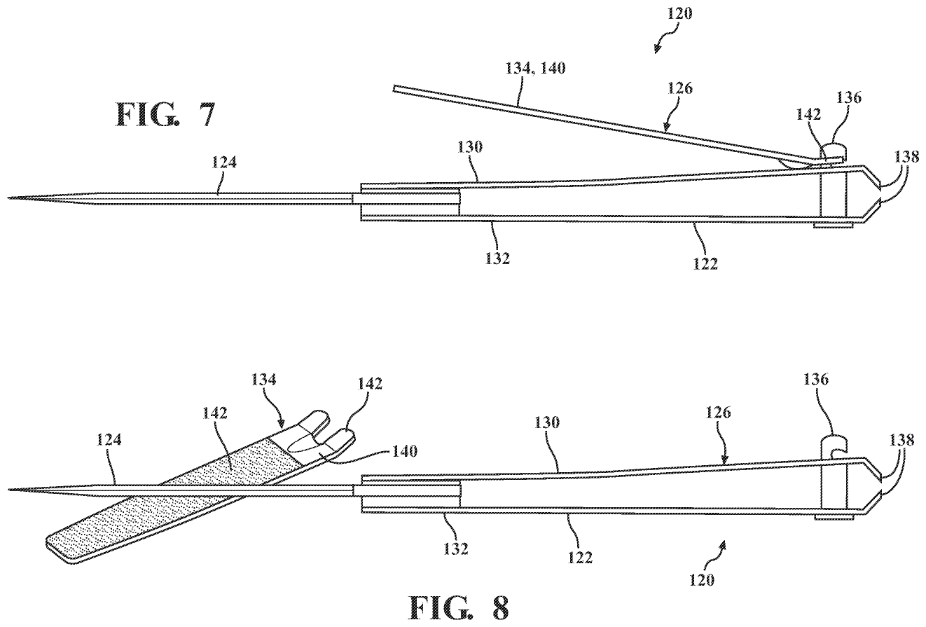

A keeper pin 136 extends between the top and bottom clipping pieces 130, 132 and is attachable with the lever 134 to hold the lever 134 on the handle 122. The lever 134 is generally rectangular with a planar first portion 140 and a second portion 142 that is angled relative to the first portion 140 at an obtuse angle. The keeper pin 136 has a hook-shaped top that engages with an opening in the angled second portion 140 of the lever 134. The lever 134 can be manipulated by the user and articulated into an extended position (shown in FIG. 7) whereby it can be pressed by the user to urge the clipping edge 138 of the top piece 130 of the clippers 126 against the clipping edge 138 of the bottom piece 132 to cut any object placed into the gap between the clipping edges 138. Thus, the clippers 126 can be used to precisely cut a range of objects, such as strings, ropes, etc. The lever 134 can also be articulated into a retracted position (shown in FIGS. 4-6) whereby an outer surface of the lever 134 is generally flush with the surrounding area of the handle 122 of the knife 120.

The clipping pieces 130, 132 are attached with one another at their ends opposite of the clipping edges 138, and the top clipping piece 130 is biased away from the bottom clipping piece 132 in a spring-like fashion such that FIG. 5 illustrates the resting positions of the top and bottom clipping pieces 130, 132. The spring-like biasing force of the top clipping piece 130 traps the second portion 140 of the lever 134 between the top clipping piece 130 and the hook-shaped top of the keeper pin 136. The lever 134 can be removed from the keeper pin 136 and separated from the handle 122 of the knife 120 by pressing down on the top clipping piece 130 to overcome the spring-like biasing force, thereby allowing the lever 134 to be disengaged from the hook-shaped top of the keeper pin 136 and removed from the knife 120.

As shown in FIG. 8, one surface of the first portion 140 of the lever 134 is made of a blade sharpening material 142, such as Novaculite, aluminum oxide, or silicon carbide. Preferably, the surface with the blade sharpening material 142 is the surface of the lever 134 that faces the handle 122 when the lever 134 is in the closed position so that the blade sharpening material 142 is hidden from view when the lever 134 is in the retracted position. To sharpen the sharp edge of the blade 124, a user can easily detach the lever 134 from the keeper pin 136 of the clippers 136 and rub the sharp cutting edge of the blade 124 against the blade sharpening material 142 of the lever 134 in a sharpening motion as illustrated in FIG. 8.

In some embodiments, the surface of the lever 134 that includes the blade sharpening material 142 may be configured for sharpening fish hooks in addition to or rather than blade edges. In these embodiments, the blade sharpening material 142 may have a texture that is specifically optimized for sharpening fish hooks.

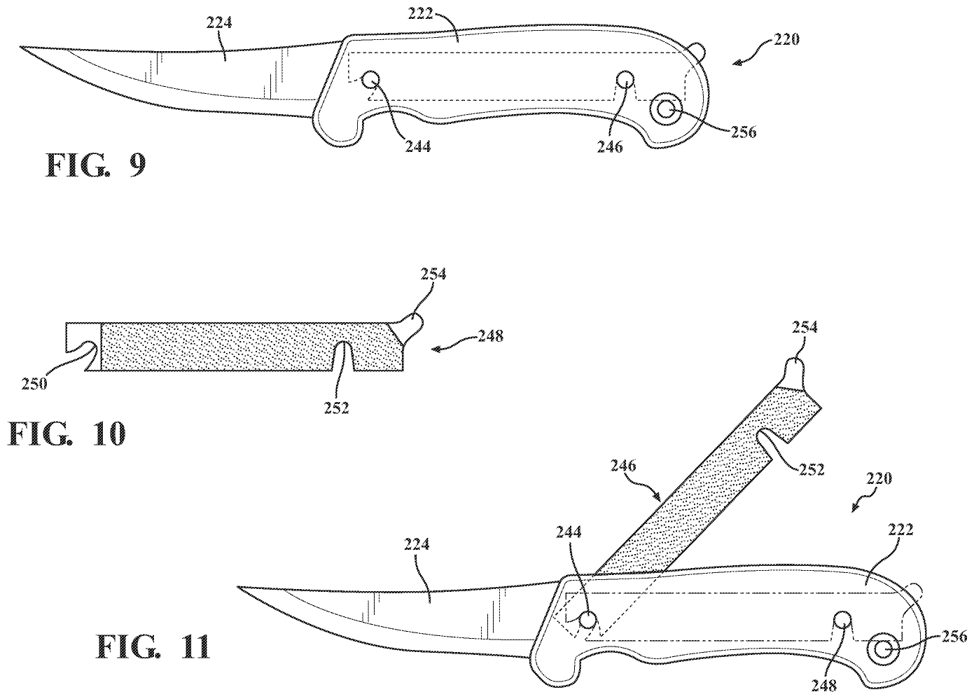

Referring now to FIGS. 9-11, third exemplary embodiment of the knife 220 is generally shown with like numerals, separated by a prefix of “2” identifying like components with the above-discussed embodiment. As discussed in further detail below, in this embodiment, the knife 220 includes a self-contained blade 224 sharpening system without the clippers 226. Specifically, in this embodiment, the knife 220 is a fixed-blade knife, meaning that the blade 224 is permanently fixed with (i.e., non-movable relative to) the handle 222. To establish this fixed engagement, a pair of pins (a first pin 244 and a second pin 246) extend through the handle 222 and the blade 224 to fix the blade 224 with the handle 222. The first and second pins 244, 246 are spaced from one another on opposite sides of the handle 222.

The handle 222 includes a slot on a side that faces opposite of the sharp cutting edge of the blade 224, and both of the first and second pins 244, 246 extend across the slot. A sharpener 248, which is made as a separate piece from the handle 222 and from the blade 224, is received in the slot and engages with the pins 242, 244 to hold the sharpener 246 within the handle 222. When engaged with the pins 242, 244, the sharpener 246 is mostly concealed. The sharpener 248 is generally rectangular in shape and has a front edge, a back edge, a top edge, and a bottom edge. The front edge has a keyhole and curved first opening 250 that faces towards the blade 224. Adjacent the back edge, the bottom edge includes a U-shaped second opening 252 that is spaced from an end of the first opening 250 by the same distance that the pins 244, 246 are spaced apart from one another. Thus, when the sharpener 248 is in the concealed position within the handle 222, the first pin 244 is received within the first opening 250, and the second pin 246 is received within the second opening 252. At the corner of the sharpener 248 where the back edge meets the top edge, the sharpener 248 further includes a tab 254, which projects out of the housing 222 such that only the tab 254 is exposed when the sharpener 248 is within the handle 222.

To remove the sharpener 248 from the handle 222, a user simply pulls the tab 254 upwardly to pivot the sharpener 248 about the first pin 244, thereby disengaging the sharpener 248 from the second pin 246, as shown in FIG. 11. Next, the user pulls the sharpener 248 rearwardly to disengage the first opening 250 from the first pin 244. The sharpener 248 can then be used to sharpen the cutting edge of the blade 224 by rubbing the cutting edge against the sharpener 248 in a sharpening motion (see, for example, FIG. 8).

To install the sharpener 248 into the handle 222, the user first inserts the front edge of the sharpener 248 into the slot on the handle 222 to receive the first pin 244 into the first opening 250 of the sharpener 248. Next, the user pivots the sharpener 248 about the first pin 244 until the second pin 246 is received within the second opening 252.

The knife 220 also includes a locking mechanism that functions to further retain the sharpener 248 within the handle 222. In the example embodiment, the locking mechanism includes a push button 256 that projects out of a side surface of the handle 222 and that engages with the sharpener 248. Pushing the button 256 allows disengagement of the sharpener 248 so that it can be removed through the process described above.

Obviously, many modifications and variations of the present invention are possible in light of the above teachings and may be practiced otherwise than as specifically described while within the scope of the appended claims. Additionally, it is to be understood that all features of all claims and all embodiments can be combined with each other as long as they do not contradict each other.

What is claimed is:

1. A knife, including:
a blade connected with a handle; and
a blade sharpener connected with the handle and detachable from the handle for sharpening a cutting edge of the blade.

2. The knife as set forth in claim 1, wherein the blade sharpener is built into a lever of a clipper that has a pair of clipping edges that can be brought together to cut an object.

3. The knife as set forth in claim 1, wherein the lever can be pivoted between an open position and a closed position, wherein when in the open position, a first portion of the lever extends away from the handle and can be pressed to bring the pair of clipping edges together, and wherein when the lever is in the closed position, the blade sharpener is hidden from view.

4. The knife as set forth in claim 3, wherein the lever is connectable with the handle via a keeper pin.

5. The knife as set forth in claim 3, wherein the clippers include a top clipping piece with one of the clipping edges and a bottom clipping piece with another of the clipping edges and wherein the top and bottom clipping pieces are at least partially spaced apart from one another by a gap.

6. The knife as set forth in claim 5, wherein the blade of the knife is pivotable relative to the handle between a closed position and an open position, and wherein the blade partially extends into the gap between the top and bottom clipping pieces when the blade is in the closed position.

7. The knife as set forth in claim 6, wherein when the blade of the knife is in the closed position, no portion of the blade is located between the clipping edges of the top and bottom clipping pieces.

8. The knife as set forth in claim 1, wherein the blade is attached with the handle through two pins that extend through a slot of the handle and wherein the blade sharpener includes a pair of slots that receive the pins to hold the blade sharpener in the slot of the handle.

9. The knife as set forth in claim 8, wherein one of the slots is keyhole shaped for receiving one of the pins, and wherein when the sharpener is retained within the slot of the handle, a tab on the sharpener extends out of the slot and can be engaged by a user to remove the sharpener from the slot of the handle.

10. A knife, comprising:
a handle;
a blade pivotably connectable with the handle and able to pivot between an open position and a closed position, a cutting edge of the blade being fully disposed within a slot in the handle when the blade is in the closed position; and
clippers incorporated into the handle, the clippers including a first clipping piece and a second clipping piece and a lever, the first and second clipping pieces having opposing clipping edges, and the lever being configured to press one of the clipping pieces towards the other clipping piece to bring the clipping edges together.

11. The knife as set forth in claim 10, wherein a blade sharpening material is formed into one surface of the lever.

12. The knife as set forth in claim 11, wherein the blade sharpening material includes at least one of Novaculite, aluminum oxide, or silicon carbide.

13. The knife as set forth in claim 11, further including a keeper pin that extends through the first and second clipping pieces and engages with the lever.

14. The knife as set forth in claim 13, wherein the lever includes a planar first portion that includes the blade sharpening material and a planar second portion that engages with the keeper pin and wherein the second portion is angled relative to the first portion at an obtuse angle.

15. The knife as set forth in claim 11, when the blade is in the closed position, a portion of the blade extends into a gap between the first and second clipping pieces.
clippers incorporated into the handle, and
the clippers including a detachable lever that includes a blade sharpening surface.
